(19) United States
(12) Patent Application Publication
(10) Pub. No.: US 2011/0099148 A1
(43) Pub. Date: Apr. 28, 2011

(54) Verification Of Remote Copies Of Data

(76) Inventor: Theodore E. Bruning, III, Colorado Springs, CO (US)

(21) Appl. No.: 12/997,478

(22) PCT Filed: Jul. 2, 2008
(86) PCT No.: PCT/US08/69025

§ 371 Date: Dec. 10, 2010

(51) Int. Cl. G06F 17/30; G06F 17/00

(52) U.S. Cl. 707/639; 707/656; 707/E17.007

(57) ABSTRACT

Synchronous mirroring of data stored in a first storage system is performed by storing a mirror copy of the data at a remote second storage system. A first snapshot of the data stored in the first storage system is created, and a second snapshot of the mirror copy in the second storage system is created. A first signature of the first snapshot and a second signature of the second snapshot are calculated, and the first and second signatures are compared to verify whether or not the data in the first storage system is identical to the mirror copy in the second storage system.

### BACKGROUND

To provide protection of data stored in a storage system, some solutions implement mirroring, in which the data of the storage system is copied to a remote storage system. The mirroring of data can be performed in a synchronous manner, in which any modification of data (such as due to a write request from a client device) at a source storage system is synchronously performed at the remote storage system prior to the client device being notified that the write request has been completed. By performing synchronous mirroring, the likelihood that the remote mirror copy at the remote storage system is different from the source storage system is reduced.

However, even though synchronous mirroring is performed, conventional techniques have not been provided to efficiently determine whether or not the mirror copy at the remote storage system is identical to the data at the source storage system. This may be an obstacle to successful failover from the source storage system to the remote storage system in case of failure of the source storage system. Consequently, an operator may be led to assume that the mirror copy is an exact duplicate of the data contained in the source storage system that has experienced a failure; however, such an assumption may not be valid and may result in data integrity issues.

### BRIEF DESCRIPTION OF THE DRAWINGS

Some embodiments of the invention are described, by way of example, with respect to the following figures:

FIG. 1 is a block diagram of an exemplary arrangement that includes a source storage system and remote storage system to maintain a mirror copy of data in the source storage system, in which a mechanism according to some embodiments can be incorporated;

FIG. 2 is a flow diagram of a process of verifying that a remote mirror copy is an identical, current copy of data in the source storage system, in accordance with an embodiment.

### DETAILED DESCRIPTION

In accordance with some embodiments, a mechanism is provided to enable verification that a mirror copy of data at a remote storage system is current (identical) with data stored in a source storage system. The “source” storage system refers to the storage system that is primarily used by one or more client systems for accessing (reading or writing) data stored in the source storage system. On the other hand, the remote storage system refers to a backup or secondary storage system that under normal circumstances is not involved in data access, but rather operates to store a copy (mirror) of the data contained in the source storage system in case of disaster or some other failure that may affect availability of data in the source storage system. The remote storage system can be located, at a location that is far away from the source storage system, in some implementations.

In some embodiments, asynchronous mirroring technique is used in which any modification of data (such as due to a write request from a client system) is synchronously communicated to the remote storage system (so that the remote storage system can update its mirror copy) prior to the source storage system providing an acknowledgment to the requesting client system that the write has been completed. Under certain scenarios, it may be desirable to verify that the mirror copy in the remote storage is current with (identical to) the data stored in the source storage system. However, performing such verification can be associated with several issues. One obstacle is that the amount of data stored in the source and remote storage system can be relatively large such that comparing the copies of data at the source storage system and remote storage system is computationally impractical. A second obstacle is that in a synchronous mirror system, the data in the source and remote storage systems may be continually changing, such that accurate verification that the two copies of data at the source and remote storage systems are the same would be difficult.

To address these issues, a mechanism according to some embodiments creates point-in-time snapshots of the data in the source storage system and of the mirror copy in the remote storage system. A first signature is then created of the point-in-time snapshot of the data in the source storage system and a second signature is created based on the point-in-time snapshot of the mirror copy in the remote storage system. The first and second signatures can be any type of value created based on the content of the data in the source storage system and the content of the mirror copy in the remote storage system. As examples, the signatures can be checksums such as cyclical redundancy check (CRC) values), hash values generated using hash functions, and so forth. A “point-in-time snapshot” (or more simply “snapshot”) of data in a storage system refers to some representation of the data created at some particular point in time. Note that a snapshot of the data in the storage system does not have to be a complete copy of the data. Instead, a snapshot can include just the changed portions of the data in the storage system. For example, a first snapshot can contain changes to the data at a first point in time a second snapshot can contain just the changes that occur between the first point in time and a second point in time, and so forth. In recreating a complete copy of the data, multiple snapshots would have to be combined, along with a base version of the data (the base version refers to the state of the data prior to any changes reflected in subsequently created snapshots).

In other implementations, other types of snapshots can be used.

By comparing signatures of snapshots in the source storage system and remote storage system, a reliable mechanism is created to efficiently verify whether the remote mirror copy of the data is identical to the data in the source storage system. By calculating signatures based on the snapshots, instead of on the underlying data, the mechanism according to some embodiments would not have to force the underlying data in the source storage system and the remote storage system to remain static while the signature generation is proceeding, which can take some amount of time. Forcing data in the source storage system and remote storage system to be static for too long a period of time may adversely impact storage system performance. which is undesirable.

In alternative embodiments, techniques of verifying whether a remote mirror copy is identical to data at a source storage system can also be performed in the context of asynchronous mirroring as well. With asynchronous mirroring, completion of a write to data at the source storage system can be acknowledged prior to the write being completed at the remote storage system.

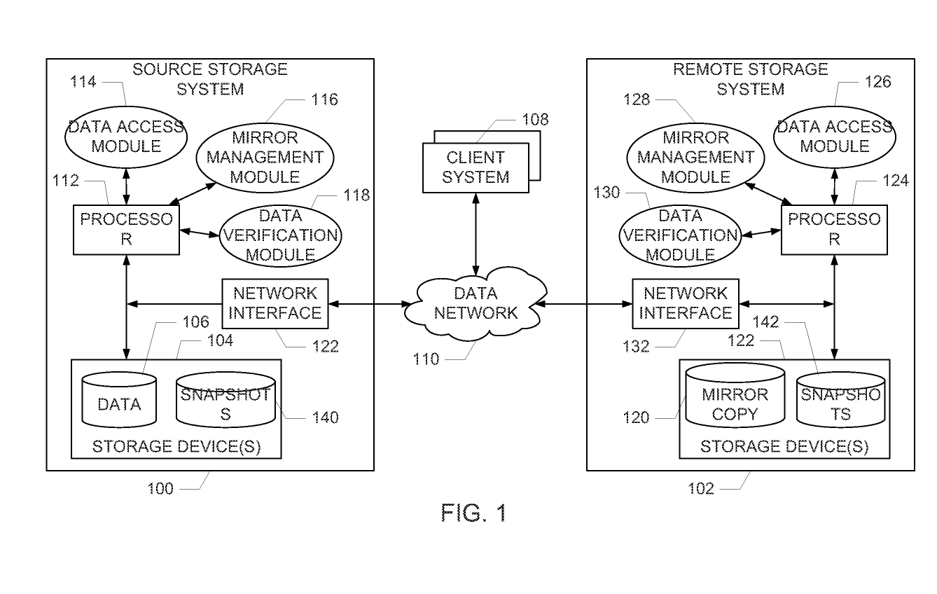

FIG. 1 shows an exemplary arrangement that includes a source storage system 100 and a remote storage system 102. The source storage system 100 includes one or more storage devices 104 (e.g., disk-based storage devices, integrated circuit storage devices, etc.) that can store data 106. The data 106 in the storage device(s) 104 can be accessed by one or more client systems 108 (e.g., client computer, personal digital assistants, etc.) over a data network 110. The accesses by the client system 108 can include read requests or write requests.

The source storage system 100 includes a processor 112 that is coupled to the storage device(s) 101. Various software modules are executable on the processor 112, including a data access module 111 (for accessing data in the storage device(s) 104), mirror management module 116 (to perform mirroring of the data 106 at the remote storage system 102), and a data verification module 118 (to verify that a mirror copy 120 at the remote storage system 102 is current (identical) to the data 106 in the source storage system 100).

The source storage system 100 also includes a network interface 122 to enable the source storage system 100 to communicate over the data network 110.

In the remote storage system 102, one or more storage devices 122 are provided, in which a mirror copy 120 of the data 106 in the source storage system 100 is kept. The storage device(s) 122 is (are) connected to a processor 124 in the remote storage system 102, Software modules, including a data access module 126, a mirror management module 128, and data verification module 130, are executable on the processor 124.

The remote storage system 102 communicates over the data network 110 through a network interface 132.

The mirror management modules 116 and 128 in the source and remote storage systems 100 and 102, respectively, cooperate to perform mirroring of the data 106 in the source storage system at the remote storage system 102 (as mirror copy 120). The data verification modules 118 and 130 in the source and remote storage systems 100 and 102, respectively, cooperate to confirm that the mirror copy 120 is current with the data 106 in the source storage system 100.

Prior to performing data verification to confirm that the mirror copy 120 is identical to the data 106 in the source storage system 100, each of the data verification modules 118 and 130 creates a corresponding snapshot 140 in the source storage system 100 and snapshot 142 in the remote storage system 102, and generates signatures based on the snapshots 140 and 142. These signatures are then compared to determine whether the mirror copy 120 is identical to the data 106. Note that during creation of the snapshots 140 and 142, the data 106 and the mirror copy 140 would have to remain static, However, creating snapshot 140 and 142 is typically a much faster process than generating signatures based on the data 106 and mirror copy 120, so that the amount of time during which the data 106 and mirror copy 120 would have to remain static during creation of the snapshots 140 and 142, respectively, would be relatively small.

The data verification performed by the data verification modules 118 and 130 can be useful in various scenarios, including in the context of a failover in response to some failure or corruption at the source storage system 100. Prior to a failover, a system operator or administrator may wish to know whether or not the mirror copy 120 is a current copy with respect to the data 106 in the source storage system 100). If not, then data recovery steps can be taken. However, if it can be confirmed that the mirror copy 120 is current (identical to the data 106), then the system can proceed to reliably failover to the remote storage system 102, and to use the mirror copy 120 as the latest data for access by the client systems 108.

Confirming whether or not the mirror copy 120 is current can also be useful in other contexts, such as to allow a system administrator to confirm whether the mirroring mechanisms are performing properly.

As noted above, the mirroring that is performed is synchronous mirroring. With synchronous mirroring, a write request from the client system 108 to the source storage system 100 (which modifies some part of the data 106 in the source storage system 100) would cause the source storage system (and more particularly, the mirror management module 116) to first transmit the write data and write request to the remote storage system 102. After the remote storage system 102 has updated the mirror copy 120, the remote storage system 102 (and more specifically, the mirror management module 128) sends back an acknowledgment to the source storage system 100. Then, after the source storage system 100 has performed the write, the source storage system 100 can send back an acknowledgment to the requesting client system 108 to indicate that the write has been completed.

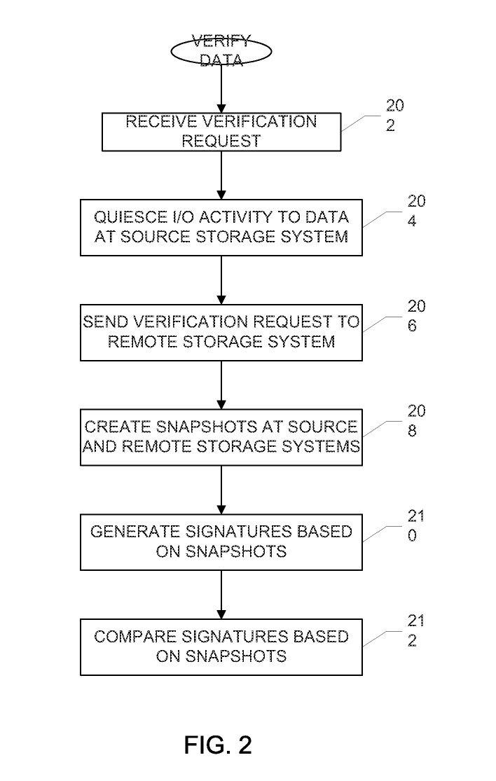

FIG. 2 shows a flow diagram of a process of verifying that the mirror copy 120 is current with the data 106 in the source storage system. The verification can be in response to a request sent from a client system 108, or the verification can be performed in response to certain events (e.g., periodically, exception events, failure events, and so forth), In response to receiving (at 202) a verification request, such as by the data verification module 118 of the source storage system 100, the data verification module 118 sends (at 204) the verification request to the remote storage system 102 to enable the source and remote storage systems to be synchronized with respect to data verification operations. At the source storage system 100, input/output (I/O) activity to data at the source storage system is quiesced (at 206) to prevent the data 106 from being modified prior to creation of the latest snapshot. Any write request in transit is first completed prior to generation of a snapshot. Quiescing the data 106 in the source storage system 100 also means that the mirror copy 120 is quiesced.

Next, a snapshot 140 of the data 106 in the source storage system 100 and another snapshot 142 of the mirror copy 120 at the remote storage system are created (at 208). Creating the snapshots at the source storage system 100 and the remote storage system is performed in a synchronized manner. Synchronizing the creation of snapshots is accomplished by the source storage system 100 quiescing the data 106 (to temporarily keep the data 106 from changing) and then exchanging messages to cause the snapshots 140 and 142 to be taken after quiescing of the data 106.

As depicted in FIG. 1, various snapshots 140 at different points in time of the data 106 are stored in the storage device(s) 104 in the source storage system 100, and various snapshots 142 at different points in time of the mirror copy 120 are stored in the storage device(s) 122 of the remote storage system 102.

Next, a first signature (e.g., checksum, hash value) of the snapshot 140 at the source storage system, and a second signature of the snapshot 142 at the remote storage system 102, are generated (at 210). Generating a signature of a snapshot refers to generating a signature based on the collection of one or more snapshots (and the base version of data) that together provide a fall representation of the current state of the data.

Next, the checksums can be exchanged between the source and remote storage systems, such as by the remote storage system 102 sending its checksum to the source storage system 100, or vice versa. At either the source storage system 100 or remote storage system 102 (the one that received the signature from the other storage system), the data verification module 118 or 130 compares (at 212) the signatures to verify whether the mirror copy is current.

If not, then some corrective action can be taken. If the signatures match, then a success indication can be provided.

The above procedure is performed in the context of synchronous mirroring. However, a similar procedure can be applied in the context of asynchronous mirroring. In the latter context, after quiescing I/O activity at the source storage system (204 in FIG. 2) and after sending the verification request (206 in FIG. 2), but prior to the creating the snapshots (208 in FIG. 2), a step to synchronize the asynchronous remote mirror copy can be performed by applying all changes since the source storage system was quiesced to the remote storage system.

Note that in some scenarios, the step of synchronizing the copy of the data at the source storage system with the mirror copy at the remote storage system may have to be performed since there is the possibility that I/O activity may have been in transit even though the requesting client system has been quiesced such that the I/O activity has not been acknowledged to the requesting client system.

Instructions of software described above including data access modules 114 and 126, mirror management modules 116 and 128, and data verification modules 118 and 130 of FIG. 1) are loaded for execution on a processor (such as processors 112 and 124 in FIG. 1). Each processor includes microprocessors, microcontrollers, processor modules or subsystems (including one or more microprocessors or microcontrollers), or other control or computing devices. A “processor” can refer to a single component or to plural components.

Data and instructions (of the software) are stored in respective storage devices, which are implemented as one or more computer-readable or computer—usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method comprising:
performing synchronous mirroring of data stored in a first storage system by storing a mirror copy of the data at a remote second storage system;
creating a first snapshot of the data stored in the first storage system and a second snapshot of the mirror copy in the second storage system;
calculating a first signature of the first snapshot and a second signature of the second snapshot; and
comparing the first and second signatures to verify whether or not the data in the first storage system is identical to the mirror copy in the second storage system.

2. The method of claim 1, wherein comparing the first and second signatures comprises one of: (1) comparing first and second checksums; and (2) comparing hash values.

3. The method of claim 1, wherein the first and second snapshots are created in a synchronized manner.

4. The method of claim 1, wherein performing synchronous mirroring comprises:
receiving, by the first storage system, a request from a client system to modify the data in the first storage system;
in response to the request, the first storage system sending an indication of the request to update the data to the second storage system;
receiving, by the first storage system, an acknowledgment of the indication from the second storage system; and
the first storage system waiting for the acknowledgment from the second storage system before the first storage system sends an acknowledgment of processing of the request to the client system.

5. The method of claim 1, wherein creating the first snapshot and the second snapshot is in response to receiving a verification request to confirm that the data stored in the first storage system is identical to the mirror copy in the second storage system.

6. The method of claim 5, further comprising:
after receiving the verification request, quiescing the data stored in the first storage system prior to creating the first snapshot and the second snapshot.

7. The method of claim 6, further comprising;
after quiescing the data in the first storage system, completing any write request in transit prior to creating the first snapshot and the second snapshot.

8. A first storage system comprising:
at least one storage device to store data;
a processor to:
perform synchronous mirroring of the data stored in the at least one storage device by causing creation of a mirror copy of the data at a remote second storage system;
in response to a request to verify that the mirror copy is identical to the data, create a first snapshot of the data stored in the at least one storage device;
cause a second snapshot of the mirror copy to be created in the second storage system;
calculate a first signature of the first snapshot;
receive a second signature of the second snapshot from the second storage system; and
compare the first and second signatures to verify whether or not the data in the at least one storage device is identical to the mirror copy in the second storage system.

9. The first storage system of claim 8, wherein the processor is to further:
quiesce the data storage in the at least one storage device after receiving the request to verify and prior to creating the first snapshot.

10. The first storage system of claim 8, wherein the processor is to further:
synchronize creation of the first snapshot and the second snapshot.

11. The first storage system of claim 8, wherein the first signature and the second signature comprise a first checksum and a second checksum, respectively.

12. The first storage system of claim 8, wherein the first signature and the second signature comprise a first hash value and a second hash value, respectively.

13. The first storage system of claim 8, wherein the first snapshot is a point-in-time representation of the data, wherein the at least one storage device further contains additional snapshots that correspond to other point-in-time representations of the data, wherein a collection of the snapshots together provide changes made to a base version of the data.

14. An article comprising at least one computer-readable storage medium containing instructions that when executed cause a system to:
perform synchronous mirroring of data stored in a first storage system by storing a mirror copy of the data at a remote second storage system;
create a first snapshot of the data stored in the first storage system and a second snapshot of the mirror copy in the second storage system;
calculate a first signature of the first snapshot and a second signature of the second snapshot; and
compare the first and second signatures to verify whether or not the data in the first storage system is identical to the mirror copy in the second storage system.

15. The article of claim 14, wherein the first and second signatures comprise one of (1) first and second checksums, respectively; and (2) first and second hash values, respectively.
